(19) United States
(12) Patent Application Publication
(10) Pub. No.: US 2014/0287129 A1
(43) Pub. Date: Sep. 25, 2014

(54) FLUID PROCESSING APPARATUS AND METHOD

(71) Applicant: Pursuit Marine Drive Limited, Little Chesterford (GB)

(72) Inventors: Paul Stuart Hutcheson, Guildford (GB); Andres Furukawa Suarez, Huntingdon (GB)

(21) Appl. No.: 14/356,141

(22) PCT Filed: Nov. 5, 2012
(86) PCT No.: PCT/GB2012/052751

§ 371 Date: May 2, 2014

(30) Foreign Application Priority Data
Nov. 3, 2011 (GB) 1119007.1

(51) Int. Cl. C12C 7/06

(52) U.S. Cl. CPC C12C 7/06
USPC 426/618; 99/278

(57) ABSTRACT

A brewing vessel (250) is provided for processing a brewing composition made up of a number of ingredients. The vessel (250) has a base (252) and contains at least one fluid processor (10) which, in use, lies below the surface level of the composition within the vessel (250). The at least one processor (10) comprises a substantially straight passage (14) having a passage inlet (16) adapted to receive the composition from within the vessel (250), and a passage outlet (18) adapted to dispatch the composition back into the vessel (250). The cross sectional area of the passage (14) does not reduce below the cross sectional area of the passage inlet (16). The processor (10) further comprises a driving fluid nozzle (34) substantially circumscribing the passage (14) and having a nozzle inlet (36) adapted to receive a supply of a driving fluid, a nozzle outlet (40) opening into the passage (14) intermediate the passage inlet (16) and passage outlet (18), and a nozzle throat (38) intermediate the nozzle inlet (36) and nozzle outlet (40), the nozzle throat (38) having a cross sectional area which is less than that of both the nozzle inlet (36) and nozzle outlet (40).

The present invention relates to the field of fluid processing and more specifically to an improved apparatus and method of batch processing fluids. The apparatus and method are particularly suited, although not exclusively so, to use in brewing processes.

A batch process is a process in which a product is created by way of a series of isolated process steps, which contrasts with a continuous process in which a product is created by way of a series of connected process steps in which the product flows continuously from one step to the next. Brewing is a good example of a batch process, in which the product is treated for relatively long periods of time in a series of isolated steps.

With sustainability and water management targets set by local and international governmental bodies, companies involved in manufacturing and food and beverage production, amongst others, must focus on the reduction of the carbon footprints generated by their processing operations. Carbon footprints are directly related to energy consumption as carbon dioxide is produced during the combustion of fossil fuels such as those used for the steam boiler of a brewery, for example.

Nowadays, producers are committed to reducing the specific thermal and electrical energy consumption needed to produce their products. In order to do so they need to implement energy saving measures such as optimising the use of fossil fuels in their production lines (e.g. steam boilers), and installing production equipment with more efficient electrical energy consumption. In addition, efficient water consumption and management has become a top priority for food and beverage producers in particular, not only for cost reasons but also to reduce the environmental impact of their processes.

Cereal cooking and “mashing in” are good examples of brewing processes where these measures could be implemented to the benefit of producers. Currently, the cereal or mash is heated by indirect thermal energy. This indirect thermal energy is mainly based on the heat transfer of steam to the product by conduction, where the steam flows through semicircular pipes or the like welded onto the bottom and the walls of the heating vessel, or tun. This form of heating has rather inefficient heat transfer and also causes fouling and burn-on of the product to the heating pipes. As well as reducing the efficiency of the cooking/heating this also has a negative impact on the wort produced at the end of the mashing process, and thus the resultant beer. Furthermore, the fouling and burn-on means that more cleaning cycles are necessary, with a resultant increase in the consumption of cleaning agents and water with their associated environmental impact.

Recently, brewers have developed solutions in order to optimise energy consumption during these processes. One of these solutions still uses indirect heat transfer, but in this case using dimple jackets with pockets on the bottom and walls inside the vessel. These jackets provide a higher surface area and micro-turbulence, resulting in a more efficient heat transfer with less energy consumption. Another solution is based on the application of direct live steam diffusion (at a pressure typically below 1 bar gauge) to the product by means of a series of steam diffusion heads placed on the bottom of the vessel. However, despite reductions in energy consumption these solutions still consume relatively high levels of energy, mainly because the vessels still require mechanical agitation means to mix the product, and steam or water jackets to heat the contents.

It is an aim of the present invention to obviate or mitigate one or more of these disadvantages.

According to a first aspect of the present invention there is provided a brewing vessel for processing a brewing composition made up of a number of ingredients, the vessel having a base and containing at least one fluid processor which, in use, lies below the surface level of the composition within the vessel, the at least one processor comprising:
a substantially straight passage having a passage inlet adapted to receive the composition from within the vessel, and a passage outlet adapted to dispatch the composition back into the vessel, wherein the cross sectional area of the passage does not reduce below the cross sectional area of the passage inlet; and
a driving fluid nozzle substantially circumscribing the passage and having a nozzle inlet adapted to receive a supply of a driving fluid, a nozzle outlet opening into the passage intermediate the passage inlet and passage outlet, and a nozzle throat intermediate the nozzle inlet and nozzle outlet, the nozzle throat having a cross sectional area which is less than that of both the nozzle inlet and nozzle outlet.

The vessel may further comprise:
a plurality of the fluid processors; and
a first driving fluid supply pipe having a first end connected to a supply of driving fluid and a second end connected to the respective nozzle inlets of each fluid processor.

The first driving fluid supply pipe may be co-axial with a central axis of the vessel and the vessel may further comprise a plurality of second driving fluid supply pipes connected to the first supply pipe and extending radially therefrom, wherein a fluid processor is located at a remote end of each second supply pipe, the nozzle inlet of each processor being connected to its corresponding secondary supply pipe.

The passage of each fluid processor has a longitudinal axis which, when viewed in plan may be substantially perpendicular to its respective second supply pipe.

The vessel may further comprise a plurality of support members, each support member supporting a respective second supply pipe upon the base.

Alternatively, the vessel may further comprise a driving fluid plenum having an inlet connected to the first driving fluid supply pipe and a plurality of outlets connected to the nozzle inlets of the respective plurality of fluid processors.

The passage of the at least one fluid processor may be angled towards the base.

The passage may have a longitudinal axis which lies at a downward angle of between 20 and 90 degrees relative to the horizontal. The downward angle may most preferably be between 25 and 35 degrees relative to the horizontal.

The vessel has a central axis, and the fluid processor may be arranged such that when viewed in plan the longitudinal axis is substantially tangential to a circle centred on the central axis.

The vessel has a central axis, and the fluid processor may be arranged such that when viewed in plan the longitudinal axis at the passage inlet is at an angle of between 20 and 50 degrees relative to a tangent of a circle centred on the central axis. The longitudinal axis at the passage inlet may be at an angle of between 25 and 35 degrees relative to the tangent of the circle centred on the central axis.

According to a second aspect of the invention there is provided a method of processing a brewing composition made up of a number of ingredients in an apparatus comprising a brewing vessel and at least one fluid processor, the method comprising:
introducing the ingredients into a brewing vessel to form the composition;
drawing the composition through a passage inlet into a substantially straight passage of the fluid processor, the passage having a passage outlet adapted to dispatch the composition back into the vessel, wherein the cross sectional area of the passage does not reduce below the cross sectional area of the passage inlet;
supplying a driving fluid to a nozzle which circumscribes the passage and opens into the passage intermediate the passage inlet and passage outlet;
accelerating the driving fluid through a throat of the nozzle, the throat having a cross sectional area which is less than that of both a nozzle inlet and a nozzle outlet;
injecting the accelerated driving fluid from the nozzle outlet into the composition within the passage; and
dispatching the composition back into the vessel.

The fluid processor may, in use, lie below the surface level of the composition within the vessel.

Alternatively, the fluid processor may lie in a recirculation loop outside the vessel, the loop having a recirculation inlet drawing the composition from the vessel to the passage of the fluid processor, and a recirculation outlet passing the composition back to the vessel from the passage of the fluid processor.

According to a third aspect of the present invention there is provided a fluid processing apparatus, comprising:
a vessel having a base and being adapted to hold a volume of a process fluid; and
a fluid processor located within the vessel such that, in use, the processor lies below the surface level of the process fluid, the processor comprising:
a substantially straight passage having a passage inlet adapted to receive process fluid and a passage outlet adapted to dispatch the process fluid back into the vessel, wherein the cross sectional area of the passage does not reduce below the cross sectional area of the passage inlet;
a driving fluid nozzle substantially circumscribing the passage and having a nozzle inlet adapted to receive a supply of a driving fluid, a nozzle outlet opening into the passage intermediate the passage inlet and passage outlet, and a nozzle throat intermediate the nozzle inlet and nozzle outlet, the nozzle throat having a cross sectional area which is less than that of both the nozzle inlet and nozzle outlet;
and wherein the passage is angled towards the base of the vessel.

The passage may have a longitudinal axis which is angled towards the base of the vessel such that the longitudinal axis lies at a downward angle of between 20 and 90 degrees relative to the horizontal. The downward angle may most preferably be between 25 and 35 degrees relative to the horizontal.

The vessel has a central axis, and the fluid processor may be arranged such that when viewed in plan the longitudinal axis is substantially tangential to a circle centred on the central axis.

The vessel has a central axis, and the fluid processor may be arranged such that when viewed in plan the longitudinal axis at the passage inlet is at an angle of between 20 and 50 degrees relative to a tangent of a circle centred on the central axis. The longitudinal axis at the passage inlet may be at an angle of between 25 and 35 degrees relative to the tangent of the circle centred on the central axis.

The passage has a longitudinal axis which may be substantially parallel with the central axis of the vessel.

The apparatus may further comprise:
a plurality of fluid processors;
a first driving fluid supply pipe entering the vessel; and
a plurality of second driving fluid supply pipes connected to the first supply pipe and extending radially therefrom;
wherein a fluid processor is located at a remote end of each second supply pipe, the nozzle inlet of each processor being connected to its corresponding secondary supply pipe.

The passage of each fluid processor may be, when viewed in plan, substantially perpendicular to its respective second supply pipe.

The vessel may further comprise a plurality of support members, each support member supporting a respective second supply pipe upon the base.

The apparatus may further comprise:
a plurality of fluid processors;
a first driving fluid supply pipe entering the vessel; and
a driving fluid plenum having an inlet connected to the first driving fluid supply pipe, and a plurality of outlets connected to the nozzle inlets of the respective plurality of fluid processors.

Preferred embodiments of the present invention will now be described, by way of example only, with reference to the accompanying drawings, in which:

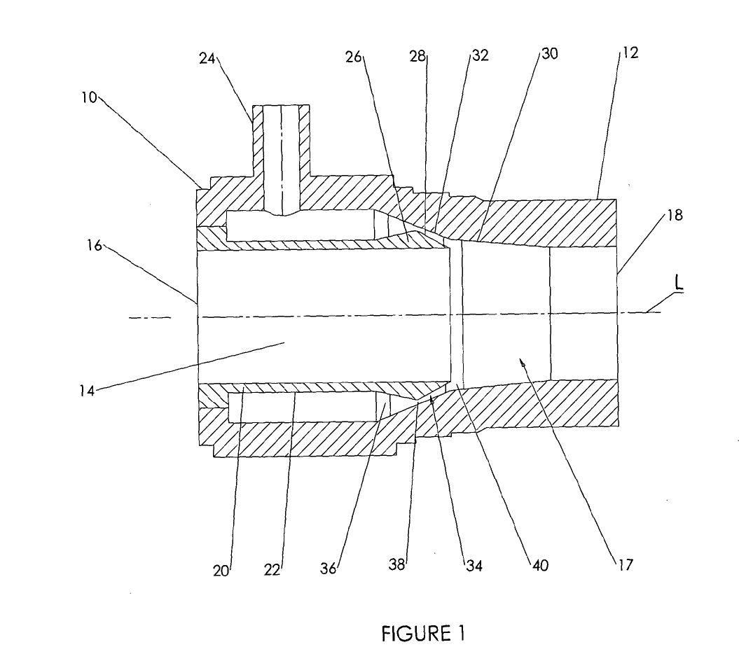

FIG. 1 is a longitudinal section view through a fluid processor;

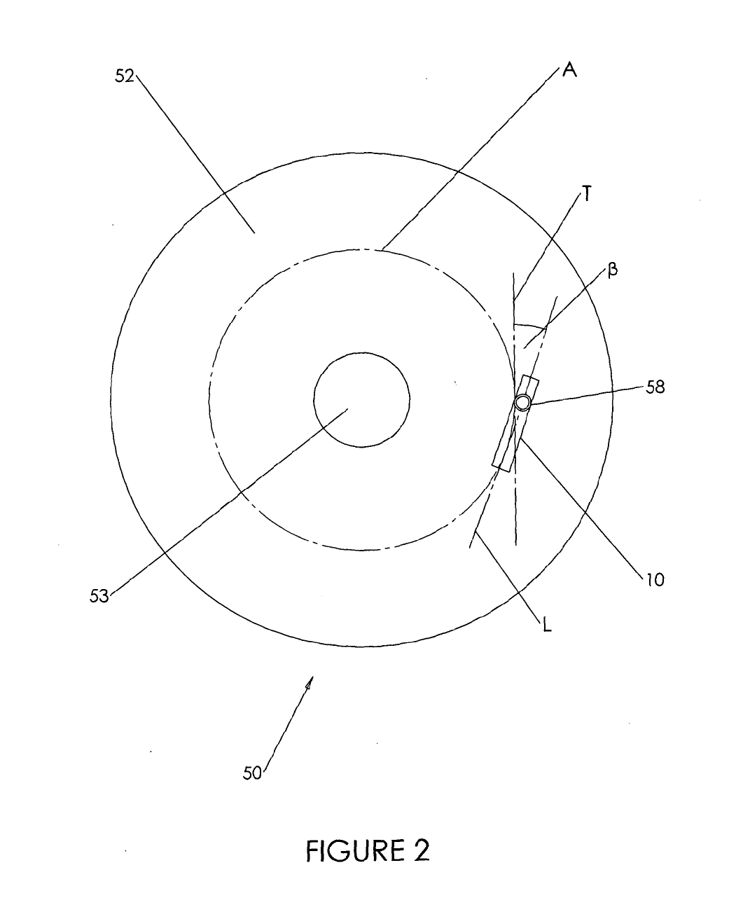

FIG. 2 is a plan view of a first embodiment of a fluid processing apparatus;

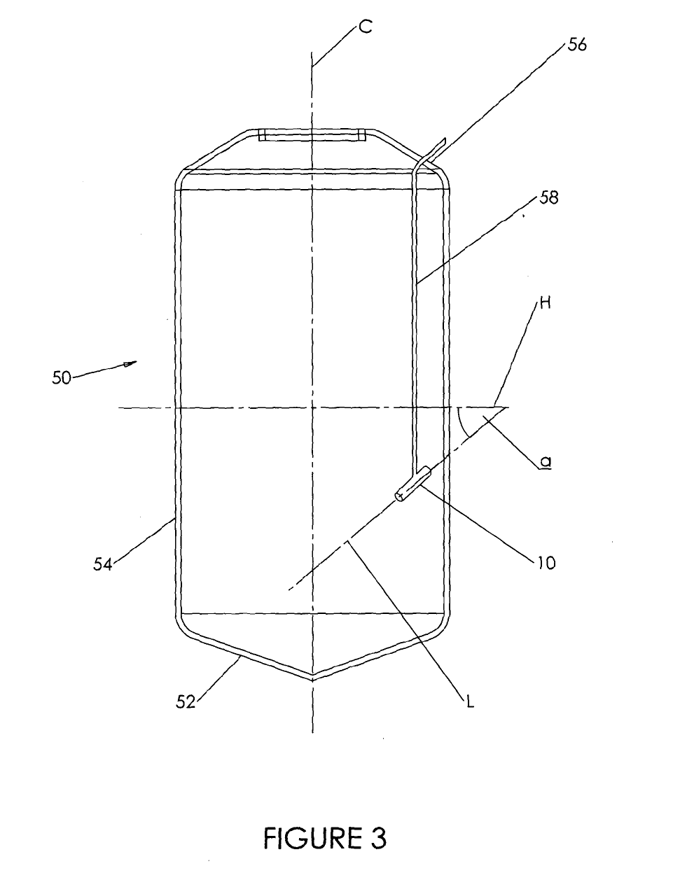

FIG. 3 is a side view of the fluid processing apparatus of FIG. 2;

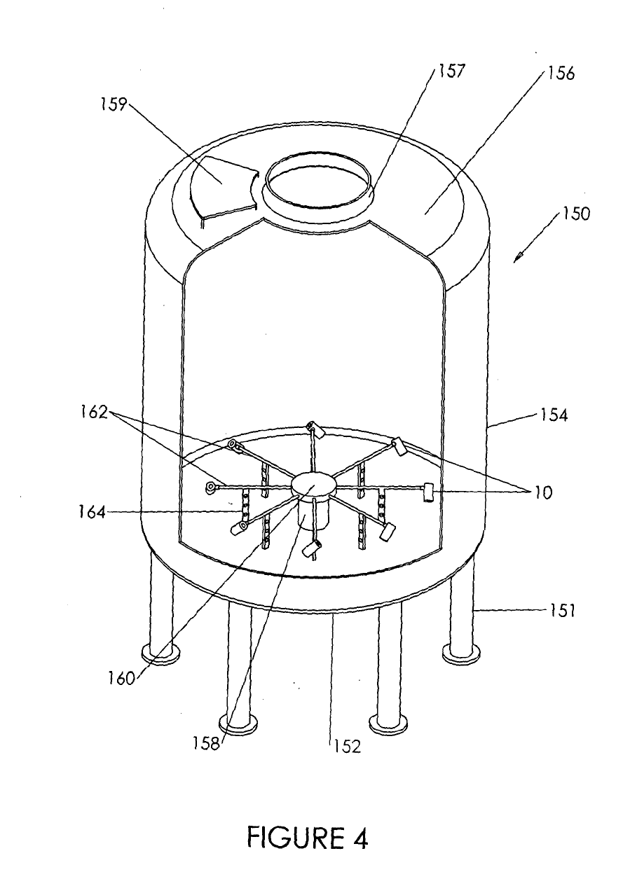

FIG. 4 is a perspective view of a second embodiment of a fluid processing apparatus;

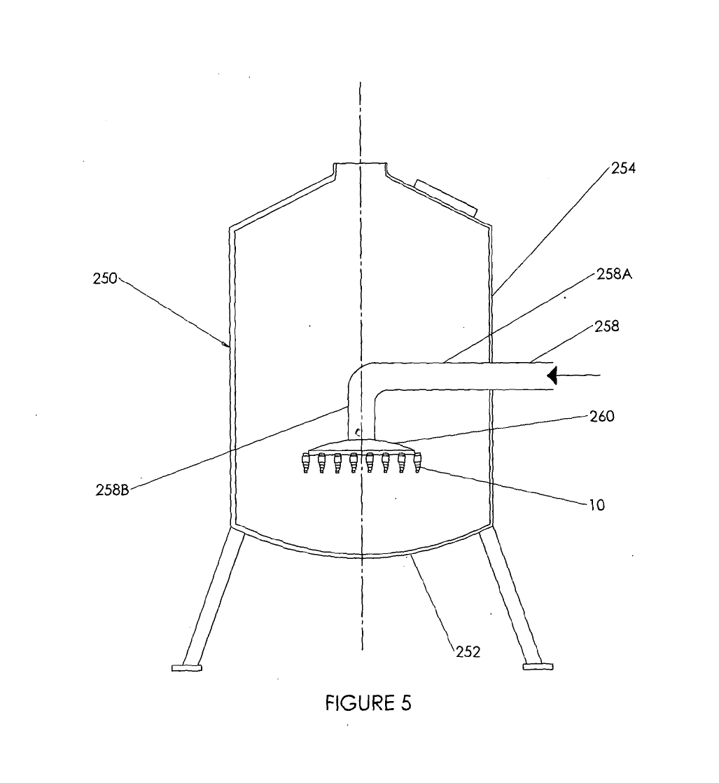

FIG. 5 is a side view of a third embodiment of a fluid processing apparatus; and

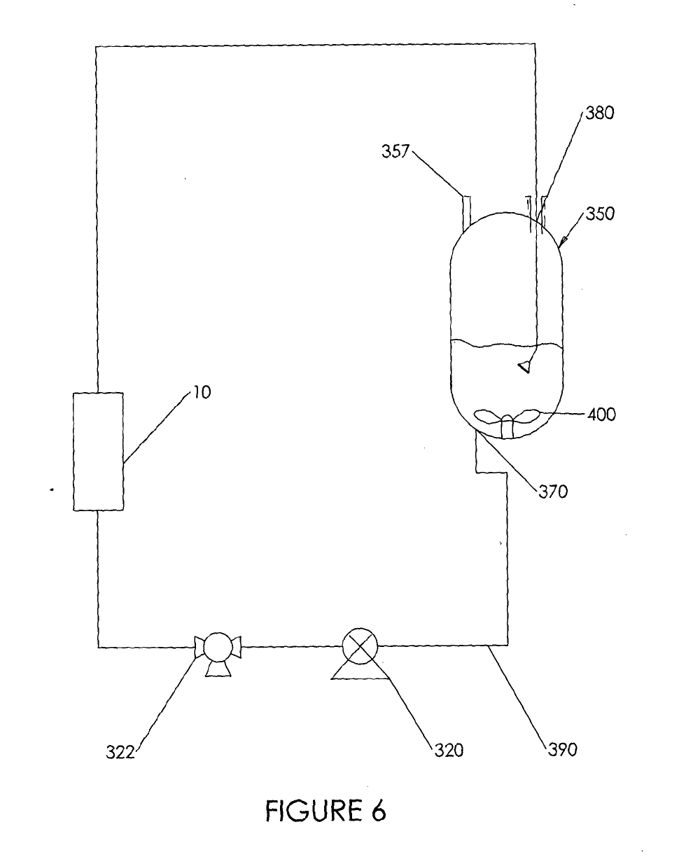

FIG. 6 is a schematic view of a fourth embodiment of a fluid processing apparatus.

FIG. 1 is a longitudinal section through a fluid processor, generally designated 10. The processor 10 comprises a housing 12 within which is defined a longitudinally extending passage 14 with a longitudinal axis L. The passage has an inlet 16 and an outlet 18 and is substantially straight and of substantially constant circular cross section. The cross sectional area of the passage 14 never reduces along its length below the cross sectional area of the inlet 16, so that any large particles that pass through the inlet 16 will meet with no constraining area reduction that prevents their motion through the rest of the passage 14.

A protrusion 20 extends axially into the housing 12 from the inlet 16 and defines exteriorly thereof a plenum 22 for the introduction of a compressible driving fluid. The plenum 22 is provided with an inlet 24 which is connectable to a source of driving fluid (not shown in FIG. 1). The protrusion 20 defines internally thereof the inlet 16 and an upstream portion of the passage 14. The protrusion 20 has a distal end 26 remote from the inlet 16. The distal end 26 of the protrusion 20 has a thickness which increases and then reduces again so as to define an inwardly tapering surface 28. The housing 12 has a wall 30, which at a location adjacent that of the tapering surface 28 of the protrusion 20 is increasing in thickness. This increase in thickness provides a portion of the wall 30 with a surface 32 which has an inward taper corresponding to that of the tapering surface 28 of the protrusion 20. Between them the tapering surface 28 of the protrusion 20 and the tapering surface 32 of the wall 30 define an annular nozzle 34. The nozzle 34 has a nozzle inlet 36 in flow communication with the plenum 22, a nozzle outlet 40 opening into the passage 14, and a nozzle throat 38 intermediate the nozzle inlet 36 and the nozzle outlet 40. The nozzle 34 is a convergent-divergent nozzle. As will be understood by the skilled reader, this type of nozzle has a nozzle throat 38 having a cross sectional area which is less than that of both the nozzle inlet 36 and the nozzle outlet 40. There is a smooth and continuous decrease in cross-sectional area from the nozzle inlet 36 to the nozzle throat 38, and a smooth and continuous increase in cross-sectional area from the nozzle throat 38 to the nozzle outlet 40. A convergent-divergent nozzle has no sudden step change in cross-sectional area, though the surface might have a roughness, or small protuberances (vortex generators, not shown) to generate turbulence in the flow passing through the nozzle 34. The passage 14 also includes a mixing region 17, which is located in the passage immediately downstream of the nozzle outlet 40.

As an example the decrease and increase in the cross-sectional area of the nozzle 34 can be linear, or may have a more complex profile. One such profile might be that the stream-wise cross-section is substantially the same as that of a De Laval nozzle, which has a cross-section of an hour-glass-type shape.

FIGS. 2 and 3 show plan and side views, respectively, of a first embodiment of a fluid processing apparatus. The apparatus comprises a vessel 50 for holding a volume of a fluid to be processed, and a fluid processor 10 of the type shown in FIG. 1 located within the vessel 50. It should be appreciated that the vessel 50 is enclosed but that it has had its top and part of its side wall removed for illustrative purposes in the respective views of FIGS. 2 and 3.

The vessel 50 is substantially cylindrical and has a base 52, a side wall 54 and a top 56. The base 52 may be concave with a centrally located flat portion 53. The vessel includes fill and drain ports (not shown) so that process fluid may enter and leave the vessel 50. These ports are closed during processing. The processor 10 is located in the vessel 50 such that it will be below the surface of the process fluid when in use. The processor 10 is attached to a driving fluid supply pipe 58 which extends through the top 56 of the vessel 50 and connects the processor 10 with a supply of a driving fluid (not shown). A seal (not shown) is provided between the outside of the supply pipe 58 and the top 56 of the vessel 50.

As can be seen best in FIG. 3, the fluid processor 10 is arranged in the vessel 50 so that the processor passage is angled downwards towards the vessel base 52. Preferably, the processor 10 is arranged such that the longitudinal axis L of the passage lies at a downward angle α of between 20 and 50 degrees relative to the horizontal plane, as represented by line H in FIG. 3. The angle α is most preferably between 25 and 35 degrees relative to the horizontal plane. References herein to the “horizontal plane” relate to a plane extending through the vessel perpendicular to the side wall 54, and should be interpreted accordingly if for some reason the vessel is not positioned in an upright position as shown in the figures.

As shown in FIG. 2, the vessel has a central axis C and as well as being angled relative to the horizontal plane H the processor 10 may also be arranged such that when viewed in plan the longitudinal axis L of the processor passage is substantially tangential to a circle A centred on the axis C. Preferably, the processor 10 is arranged such that when viewed in plan the longitudinal axis L at the passage inlet 16 is at an angle β relative to a tangent T of the circle A. Most preferably, the angle β is between 25 and 35 degrees.

The fluid processing apparatus of FIGS. 1-3 operates as follows. Initially, driving fluid flows into the processor 10 via the supply pipe 58 and the plenum 22. In this preferred embodiment, the driving fluid is a compressible gas, such as steam, carbon dioxide or nitrogen, which is preferably supplied at a supply pressure of between 1.5 and 2.5 bar gauge. The convergent-divergent shape of the nozzle 34 accelerates the driving fluid and a high velocity jet of driving fluid is injected into the fluid passage 14 from the nozzle outlet 40. At the same time, a process fluid contained within the vessel 50 is drawn through the inlet 16 of the processor passage 14. As the driving fluid is injected into the passage 14 from the nozzle 34 it expands and imparts a low shear force on the process fluid as it passes the nozzle outlet 40. The differences in velocity, temperature and pressure between the driving fluid and the process fluid lead to momentum and heat transfer from the expanding, comparatively high velocity driving fluid to the lower velocity process fluid, causing both the velocity and temperature of the process fluid to rise. Some of the process fluid may undergo a liquid to gas phase change as a result of the energy transfer from the driving fluid. In addition, as the driving fluid flows from the reduced cross sectional area of the nozzle 34 into the comparatively large cross sectional area of the mixing region 17 the rapid change in the pressure and velocity of the driving fluid and the shear between it and the process fluid generates a degree of turbulence and vortices, leading to the thorough mixing of the constituents of the process fluid. The preferred driving fluid supply pressure range is selected as it is sufficient for the driving fluid to increase the momentum of the process fluid without harming any of the process fluid constituents.

As the flow heads towards the outlet 18 of the passage 14 it will begin to decelerate. This deceleration will result in an increase in pressure within the passage 14. At a certain point within the passage 14, the decrease in velocity and rise in pressure will result in a condensation of any vapour within the process flow, with the flow returning to the liquid phase (with, where present, solid particles contained therein) before leaving the outlet 18 back into the vessel 50. In this manner, the fluid processing apparatus not only heats and mixes the process fluid within the fluid processor, but is also continually stirring the fluid around the vessel without the need for any mechanical agitation means.

A second embodiment of a fluid processing apparatus is shown in FIG. 4. The apparatus comprises a vessel 150 for holding a volume of a fluid to be processed, and a plurality of fluid processors 10 of the type shown in FIG. 1 located within the vessel 150. It should be appreciated that the vessel 150 is enclosed but that it has had part of its side wall removed for illustrative purposes in FIG. 4.

The vessel 150 is substantially cylindrical and has a base 152, a side wall 154 and a top 156. The vessel includes fill and drain ports (not shown) so that process fluid may enter and leave the vessel 150. These ports are closed during processing. The vessel 150 may be provided with a number of supporting legs 151. The top 156 may include a ventilation stack 157 and an inspection hatch 159.

The processors 10 are located in the vessel 150 such that they will be below the surface of the process fluid when in use. A first driving fluid supply pipe 158 extends upwards through the base 152 into the vessel 150 and is connected to a manifold 160. The manifold 160 has an inlet in fluid communication with the supply pipe 158 and a number of radially extending outlets leading off the inlet. Connected to each outlet of the manifold 160 is a corresponding second driving fluid supply pipe 162, each of which extends radially outward from the manifold 160. At the remote end of each supply pipe 162 is a fluid processor 10, and the plenum 22 of each processor 10 is connected to its respective supply pipe 162 so as to receive driving fluid from the supply pipe 158 and manifold 160. The second supply pipes 162 may each include a support 164 attached to the base 152 of the vessel 150. The second supply pipes 162 and associated fluid processors 10 are preferably circumferentially spaced about the manifold 160 such that angle between each adjacent supply pipe 162 is the same. When the apparatus is viewed in plan, the passage of each processor 10 may be substantially perpendicular to its corresponding second supply pipe 162.

Referring back to FIG. 1, each fluid processor 10 is arranged in the vessel 150 so that the processor passage 14 is angled downwards towards the vessel base 152. As in the first embodiment, each processor 10 may be arranged such that the longitudinal axis L lies at a downward angle α of between 20 and 50 degrees relative to the horizontal plane, as illustrated in FIG. 3 and as already defined above. As with the first embodiment, the angle α is most preferably between 25 and 35 degrees relative to the horizontal plane.

As already illustrated in FIG. 2, each processor 10 in the second embodiment may also be arranged such that when viewed in plan the longitudinal axis L of the processor passage is substantially tangential to a circle A centred on the axis C. Each processor 10 may be arranged such that when viewed in plan the longitudinal axis L at the passage inlet 16 is at an angle β relative to a tangent T of the circle A. Most preferably, the angle β is between 25 and 35 degrees.

The processors 10 of the second embodiment collectively operate in the same manner as the processor of the first embodiment, and that operation will therefore not be discussed again in detail here.

A third embodiment of a fluid processing apparatus is shown in FIG. 5. The apparatus comprises a vessel 250 for holding a volume of a fluid to be processed, and a plurality of fluid processors 10 of the type shown in FIG. 1 located within the vessel 250. It should be appreciated that the vessel 250 is enclosed but that it has had part of its side wall removed for illustrative purposes in FIG. 5.

The vessel 250 is substantially identical to the vessel employed in the second embodiment shown in FIG. 4, and the features shared between the two vessels will not be described again here. The processors 10 are located in the vessel 250 such that they will be below the surface of the process fluid when in use. A first driving fluid supply pipe 258 extends through the side wall 254 into the vessel 250.

The supply pipe has a first section 258A which is substantially horizontal (or else perpendicular to a central axis C of the vessel if the vessel is not located on a horizontal surface) and a second section 258B which is substantially vertical (or else co-axial with the central axis C of the vessel if the vessel is not located on a horizontal surface). The second section 258B of the supply pipe 258 is connected to a driving fluid plenum 260.

The driving fluid plenum 260 has an inlet in fluid communication with the second supply pipe section 258B and a number of outlets, each of which is connected to the processor plenum 22 of a fluid processor 10 (see FIG. 1) so that each processor 10 receives driving fluid from the supply pipe 258. The driving fluid plenum 260 is preferably elongate and extends transversely across the vessel 250, with the associated fluid processors 10 equidistantly spaced along the underside of the driving fluid plenum 260.

As with the previous embodiments each fluid processor 10 is arranged in the vessel 250 so that the longitudinal axis L of the processor passage 14 (see FIG. 1) is angled downwards towards the vessel base 252. However, in this third embodiment each processor 10 is arranged such that the longitudinal axis L is substantially parallel to the central axis C of the vessel. In other words, the longitudinal axis L of each processor is at substantially 90 degrees relative to the horizontal plane, as illustrated in FIG. 3 and as already defined above.

The processors 10 of the third embodiment collectively operate in the same manner as the processor of the first embodiment, and that operation will therefore not be discussed again in detail here.

A fourth embodiment of a fluid processing apparatus is shown in FIG. 6. This embodiment of the apparatus comprises a vessel in the form of an insulated mash cooker 350 having a vent stack 357, and a fluid outlet 370 and fluid inlet 380. The outlet 370 and inlet 380 are fluidly connected together by a recirculation loop 390. A pump 320 is provided on the loop 390, as well as a drain/fill valve 322. A mechanical agitator 400 may be located at the bottom of the vessel 350.

A fluid processor 10 of the type shown in FIG. 1 is also located on the loop 390. Referring to FIG. 1, the passage inlet 16 and outlet 18 are connected to the loop 390 so that process fluid can pass around the loop 390 and through the processor 10. The nozzle plenum 22 is connected to a source of driving fluid (not shown in FIG. 6).

The operation of this fourth embodiment of the apparatus will now be described with reference to both FIGS. 1 and 6. Initially a process fluid, which in this example is brewing cereal mash, is formed from a number of ingredients and is introduced into the apparatus via the drain/fill valve 322 under the action of an external pump (not shown). If present, the mechanical agitator 400 may run during the entire process at various speeds. Once the drain/fill valve 322 is closed, the internal pump 320 is activated and begins to pump the cereal mash from the vessel 350 into the recirculating loop 390. The cereal mash drawn into the loop 390 will enter the passage 14 of the fluid processor 10 whereupon steam will be injected into the mash in the same manner as described in respect of the preceding embodiments. This phase is known as the “heating” phase, and will continue until such time as the cereal mash in the vessel 350 reaches a rolling cooking at the desired temperature (e.g. 95-100 deg Celsius).

The steam injection from the nozzle 34 creates a low pressure region in the mixing chamber 17 downstream of the nozzle outlet 40, which occasions induction of the cereal mash through the passage 14. Because the passage 14 has a straight through axial path and lack of any constrictions it provides a substantially constant dimension bore which presents no obstacle to the flow.

The fluid processing apparatus and method of the present invention provide significant benefits in terms of reductions in both energy consumption and processing times. Reductions in energy consumption are obtained thanks to the increased thermal energy obtained via direct injection of the driving fluid at low pressure, as well as through the removal of the need for a mechanical agitator within the vessel. Furthermore an additional, environmental benefit is provided by the present invention due to the substantial reduction of burn-on on the internal walls of the vessel and the consequent reduction in use of chemical cleaning agents, cleaning cycle times, and associated water consumption.

The fluid processor utilised in the apparatus and method provides enhanced and more efficient heat transfer from the driving fluid to the process fluid. It also avoids temperature shock, hot-spots, burn-on and fouling during the processing period. Additionally, the present invention provides enhanced mixing and creates a homogenous mix of the process fluid when compared to that available through existing mechanical agitation means. Positioning the fluid processor in the vessel so that it is angled in the direction of the vessel base further improves mixing performance as it prevents sedimentation by disturbing any particles which have fallen to the bottom of the vessel. In addition, mixing can be still further improved by positioning the fluid processor in the vessel such that it is tangential to a circle drawn around the central axis of the vessel or angled relative to the tangent, as the flow from the processor stirs the contents around the vessel. Therefore, steam jackets and agitators are no longer required. Finally, the relative simplicity of the apparatus allows it to be easily integrated in new processing facilities or else retrofitted in existing processing facilities with minimal disruption.

The apparatus and method of the present invention are particularly suited to use in brewing and in particular for cereal cooking and the creation of a brewing mash. In such a case milled grains (e.g. malted barley) and water would be added to the vessel as the mash constituents, and then the apparatus would process these constituents in the manner already described above. The driving fluid used in this case would be food grade or “culinary standard” steam, that is steam created using non-volatile chemicals in a steam boiler and then filtered through an appropriate steam filter.

A trial has already been carried out utilising the apparatus and method of the present invention for a mashing process. In the trial, culinary grade steam was supplied to the fluid processor within the vessel at a supply pressure of between 1.5 and 2.5 bar gauge at the stages in the process where the temperature of the mash had to be increased. In this trial mashing-in was carried out at a temperature of 52 deg C. for 10 minutes, followed by a rest time of 20 minutes. The fluid processor was then activated and through processing raised the temperature of the mash to 62 deg C., followed by a rest time of 30 minutes when the processor was deactivated. Finally, the processor was again activated and raised the temperature of the mash to 72 deg C., and the processor was then deactivated for a further rest time of 30 minutes.

During the trial the fluid processor was angled 30° down relative to the horizontal plane, with the longitudinal axis of the processor passage at the passage inlet being at 30° relative to the tangent of a circle centred on the central axis of the vessel. The density of the malted barley was estimated at 1290 kg/m³, based on a liquor to grain mash ratio of 3:1 and a known mash mixture density of 1097 kg/m³. This mash mixture consisted of wort (density 1044 kg/m³; viscosity 1.5 mPa·s) and malt particles. The steam flow was set at 1.68 kg/min and this equated to approximately 50 kg/min of total process flow through the fluid processor.

Under these trial conditions, the present invention provided a mash heating rate of 2.5K/min at a low steam pressure of 2 bar (±0.3 bar) gauge. This proves that the present invention can offer quicker heating of the mash and consequently faster processing with resultant environmental benefits through reduced consumption of energy, water and cleaning detergents. The trial also showed that the mixing of the mash with the present invention was extremely effective, thereby removing the need for an energy-consuming mechanical agitator with the brewing vessel or mash tun.

A second trial with maize grist and rice has also been carried out utilising the apparatus and method of the present invention for a cereal cooking process. In the trial, culinary grade steam was supplied to a fluid processor located on a recirculation loop outside the “cooking” vessel. The steam was supplied at a supply pressure of between 2.8 and 3.2 bar gauge at the stages in the process where the temperature of the cereal had to be increased. In this trial the cooking was carried out at a temperature of 60 deg C. for 10 minutes, followed by a rest time of 10 minutes. The fluid processor was then re-activated and through processing raised the temperature of the mash to 85 deg C., followed by a rest time of 15 minutes after the processor was deactivated. Finally, the processor was again activated and raised the temperature of the mash to 100 deg C., and the processor was then deactivated for a further rest time of 20 minutes.

Under these trial conditions, the present invention provided a cereal cooking rate of 3.5 deg K/min at a steam pressure of 3.0 bar (±0.2 bar) gauge. This again proved that the present invention can offer quicker heating of the mash and consequently faster processing with resultant environmental benefits.

Comprehensive tests were also performed on the resultant mashes and the final brews by the Versuchs- and Lehransalt für Brauerei in Berlin, Germany and Doemens Academy GmbH in Munich, Germany. These tests established that there were no clear differences or negative trends associated with mashes created using the present invention and those created by existing methods. Similarly, no negative effects were determined in relation to the resultant beer.

Although the present invention is suitable for use in brewing processes in particular, it is not limited to this field of application. For example, the present invention may also be employed in food production and in heating/cooking processes in particular. In fact, the present invention may be used in any field of application which requires the processing or treatment of compositions or slurries made up of liquids and grains.

Modifications and improvements may be incorporated without departing from the scope of the present invention.

1. A brewing vessel for processing a brewing composition made up of a number of ingredients, the vessel having a base and containing at least one fluid processor which, in use, lies below the surface level of the composition within the vessel, the at least one processor comprising:
a substantially straight passage having a passage inlet adapted to receive the composition from within the vessel, and a passage outlet adapted to dispatch the composition back into the vessel, wherein the cross sectional area of the passage does not reduce below the cross sectional area of the passage inlet; and
a driving fluid nozzle substantially circumscribing the passage and having a nozzle inlet adapted to receive a supply of a driving fluid, a nozzle outlet opening into the passage intermediate the passage inlet and passage outlet, and a nozzle throat intermediate the nozzle inlet and nozzle outlet, the nozzle throat having a cross sectional area which is less than that of both the nozzle inlet and nozzle outlet.

2. The vessel of claim 1, further comprising a plurality of the fluid processors; and a first driving fluid supply pipe having a first end connected to a supply of driving fluid and a second end connected to the respective nozzle inlets of each fluid processor.

3. The vessel of claim 2, wherein the first driving fluid supply pipe is co-axial with a central axis of the vessel, and the vessel further comprises a plurality of second driving fluid supply pipes connected to the first supply pipe and extending radially therefrom, wherein a fluid processor is located at a remote end of each second supply pipe, the nozzle inlet of each processor being connected to its corresponding secondary supply pipe.

4. The vessel of claim 3, wherein the passage of each fluid processor has a longitudinal axis which, when viewed in plan, is substantially perpendicular to its respective second supply pipe.

5. The vessel of claim 3, further comprising a plurality of support members, each support member supporting a respective second supply pipe upon the base.

6. The vessel of claim 2, further comprising a driving fluid plenum having an inlet connected to the first driving fluid supply pipe and a plurality of outlets connected to the nozzle inlets of the respective plurality of fluid processors.

7. The vessel of claim 1, wherein the passage of the at least one fluid processor is angled towards the base.

8. The vessel of claim 7, wherein the passage has a longitudinal axis which lies at a downward angle of between 20 and 90 degrees relative to the horizontal.

9. The vessel of claim 8, wherein the downward angle is between 25 and 35 degrees relative to the horizontal.

10. The vessel of claim 8, wherein the vessel has a central axis, and the fluid processor is arranged such that when viewed in plan the longitudinal axis at the passage inlet is at an angle of between 20 and 50 degrees relative to a tangent of a circle centred on the central axis.

11. The vessel of claim 10, wherein the longitudinal axis at the passage inlet is at an angle of between 25 and 35 degrees relative to the tangent of the circle centred on the central axis.

12. A method of processing a brewing composition made up of a number of ingredients in an apparatus comprising a brewing vessel and at least one fluid processor, the method comprising:
introducing the ingredients into the brewing vessel to form the composition;
drawing the composition through a passage inlet into a substantially straight passage of the fluid processor, the passage having a passage outlet adapted to dispatch the composition back into the vessel, wherein the cross sectional area of the passage does not reduce below the cross sectional area of the passage inlet; supplying a driving fluid to a nozzle which circumscribes the passage and opens into the passage intermediate the passage inlet and passage outlet;
accelerating the driving fluid through a throat of the nozzle, the throat having a cross sectional area which is less than that of both a nozzle inlet and a nozzle outlet;
injecting the accelerated driving fluid from the nozzle outlet into the composition within the passage; and
dispatching the composition back into the vessel.

13. The method of claim 12, wherein the fluid processor lies, in use, below the surface level of the composition within the vessel.

14. The method of claim 12, wherein the fluid processor lies in a recirculation loop outside the vessel, the loop having a recirculation inlet drawing the composition from the vessel to the passage of the fluid processor, and a recirculation outlet passing the composition back to the vessel from the passage of the fluid processor.

15. A fluid processing apparatus, comprising:
a vessel having a base and being adapted to hold a volume of a process fluid; and
a fluid processor located within the vessel such that, in use, the processor lies below the surface level of the process fluid, the processor comprising:
a substantially straight passage having a passage inlet adapted to receive process fluid and a passage outlet adapted to dispatch the process fluid back into the vessel, wherein the cross sectional area of the passage does not reduce below the cross sectional area of the passage inlet;
a driving fluid nozzle substantially circumscribing the passage and having a nozzle inlet adapted to receive a supply of a driving fluid, a nozzle outlet opening into the passage intermediate the passage inlet and passage outlet, and a nozzle throat intermediate the nozzle inlet and nozzle outlet, the nozzle throat having a cross sectional area which is less than that of both the nozzle inlet and nozzle outlet; and
wherein the passage is angled towards the base of the vessel.

16. The apparatus of claim 15, wherein the passage has a longitudinal axis which is angled towards the base of the vessel such that the longitudinal axis lies at a downward angle of between 20 and 90 degrees relative to the horizontal.

17. The apparatus of claim 16, wherein the downward angle is between 25 and 35 degrees relative to the horizontal.

18. The apparatus of claim 16, wherein the vessel has a central axis, and the fluid processor is arranged such that when viewed in plan the longitudinal axis at the passage inlet is at an angle of between 20 and 50 degrees relative to a tangent of a circle centred on the central axis.

19. The apparatus of claim 18, wherein the longitudinal axis at the passage inlet is at an angle of between 25 and 35 degrees relative to the tangent of the circle centred on the central axis.

20. The apparatus of claim 15, wherein the passage has a longitudinal axis which is substantially parallel with the central axis of the vessel.

21. The apparatus of claim 15, further comprising:
a plurality of fluid processors;
a first driving fluid supply pipe entering the vessel; and
a plurality of second driving fluid supply pipes connected to the first supply pipe and extending radially therefrom;
wherein a fluid processor is located at a remote end of each second supply pipe, the nozzle inlet of each processor being connected to its corresponding secondary supply pipe.

22. The apparatus of claim 21, wherein the passage of each fluid processor is, when viewed in plan, substantially perpendicular to its respective second supply pipe.

23. The apparatus of claim 21, wherein the vessel further comprises a plurality of support members, each support member supporting a respective second supply pipe upon the base.

24. The apparatus of claim 15, further comprising:
a plurality of fluid processors;
a first driving fluid supply pipe entering the vessel; and
a driving fluid plenum having an inlet connected to the first driving fluid supply pipe, and a plurality of outlets connected to the nozzle inlets of the respective plurality of fluid processors.
